(19) United States
(12) Patent Application Publication
(10) Pub. No.: US 2006/0132486 A1
(43) Pub. Date: Jun. 22, 2006

(54) Rendering apparatus and method for real-time global illumination in real light environment

(75) Inventors: Sung-Ye Kim, Daejon (KR); Jin-Seo Kim, Daejon (KR); Hae-Dong Kim, Daejon (KR); Maeng-Sub Cho, Daejon (KR); Byoung-Tae Choi, Daejon (KR); Hyun-Bin Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/295,839

(22) Filed: Dec. 6, 2005

(30) Foreign Application Priority Data
Dec. 20, 2004 (KR) 10-2004-0108828

(51) Int. Cl. G06T 17/00

(52) U.S. Cl. 345/420

(57) ABSTRACT

A rendering apparatus for real-time global illumination and a method thereof are disclosed. The rendering apparatus includes: a spherical harmonic processor for creating light samples and creating spherical harmonics basis functions; a light model processor for transforming radiance of a HDRI image to spherical harmonics light coefficients using the spherical harmonic basis functions; a radiance transfer processor for previously calculating coefficients of a visibility and a geometric term for a global illumination model using the spherical harmonic basis function; a BRDF processor for generating a database of BRDF data and calculating coefficients of the BRDF data through smoothing; and a render unit for rendering the spherical harmonic light coefficients, the coefficients for the visibility and the geometric term, and the BRDF data coefficient using a rendering equation expressed as a dot product of a vector.

### FIELD OF THE INVENTION

The present invention relates to an apparatus and a method for rendering; and more particular, to a rendering apparatus and a method thereof for creating realistic global illumination effect on a 3-D object in real-time through defining a rendering equation in frequency domain and using the defined rendering equation with real light information and reflectance characteristics data of a surface of an object.

### DESCRIPTION OF RELATED ART

Recently, there are many studies in actively progress to develop a technology for rendering a virtual object with global illumination effect in real time and to apply the same in a field valuing the real-time rendering above everything else, i.e., a computer game.

However, there is no such technology introduced for creating realistic global illumination effect after fully reflecting surface characteristics of various objects up to now. Especially, a technology for providing global illumination effect on the 3-D object in real time is not introduced.

Conventionally, surface characteristics of objects are expressed using typical equations introduced by Phong, Blinn and Cook-Torrance. However, characteristics of the equations are not exactly matched with the surface characteristics of a target object, and the equations cannot be calculated in real time for expressing the surface characteristics of the target objects. Therefore, it is impossible to express the object with the global illumination effect, i.e., soft shadow or inter-reflection, in real-time.

### SUMMARY OF THE INVENTION

It is, therefore, an object of the present invention to provide a rendering apparatus and a method thereof for providing realistic global illumination effect on a virtual 3-D object in real-time through defining a rendering equation in frequency domain and using the defined rendering equation with real light information and reflectance characteristics data of a surface of an object.

In accordance with an aspect of the present invention, there is provided a rendering apparatus for real-time global illumination including: a spherical harmonic processing unit for creating light samples as light directions for omni-direction, and creating spherical harmonics basis functions for each of the light samples; a light model processing unit for transforming light information (radiance) of a high dynamic range imaging (HDRI) image to spherical harmonics light coefficients using the spherical harmonic basis functions; a radiance transfer processing unit for previously calculating coefficients of a visibility and a geometric term for a global illumination model using the spherical harmonic basis function, where the coefficients of the visibility and the geometric term denote transfer-characteristics of the light information (radiance); a bidirectional reflectance distributed function (BRDF) processing unit for generating a database of BRDF data which is information about reflectance characteristics of an object's surface and calculating coefficients of the BRDF data through smoothing; and a rendering unit for rendering the spherical harmonic light coefficients, the coefficients for the visibility and the geometric term, and the BRDF data coefficient using a rendering equation expressed as a dot product of a vector.

In accordance with another aspect of the present invention, there is provided a rendering method for real-time global illumination including the steps of: a) creating light samples as light directions for omni-direction, and creating spherical harmonics basis functions for each of the light samples; b) transforming light information (radiance) of a high dynamic range imaging (HDRI) image to spherical harmonics light coefficients using the spherical harmonic basis functions; c) previously calculating coefficients of a visibility and a geometric term for each vertex of 3-D model using the spherical harmonic basis functions, where the coefficients for the visibility and the geometric term denote transfer-characteristics of the light information (radiance) when a 3-D object is in a sphere space with the light samples; d) generating a database of bidirectional reflectance distributed function (BRDF) data which is information about reflectance characteristics of an object's surface and calculating coefficients of the BRDF data through smoothing; and e) rendering the spherical harmonic light coefficients, the coefficients for the visibility and the geometric term, and the BRDF data coefficient using a rendering equation expressed as a dot product of a vector.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a rendering apparatus for real-time global illumination in accordance with a preferred embodiment of the present invention;

FIG. 2 is a block diagram for describing a rendering method of real-time global illumination in accordance with a preferred embodiment of the present invention;

FIG. 3 is a flowchart of a rendering method for real-time global illumination in accordance with a preferred embodiment of the present invention;

FIG. 4 shows sample data for omni-direction of 360°;

FIG. 5 is a view for describing a generating spherical harmonic basis function in accordance with a preferred embodiment of the present invention;

FIG. 6 shows a HDRI image;

FIG. 7 is a view for describing spherical harmonic coefficients in accordance with a preferred embodiment of the present invention;

FIG. 8 shows BRDF data having Lambertian characteristics; and

FIG. 9 shows BRDF data having glossy characteristics.

### DETAILED DESCRIPTION OF THE INVENTION

A rendering apparatus and method for real-time global illumination in real light environment in accordance with the invention will become apparent from the following description of the embodiments with reference to the accompanying drawings.

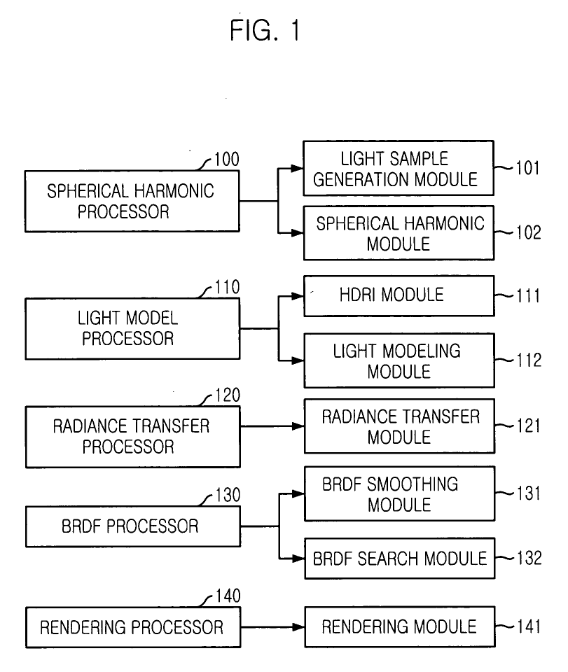

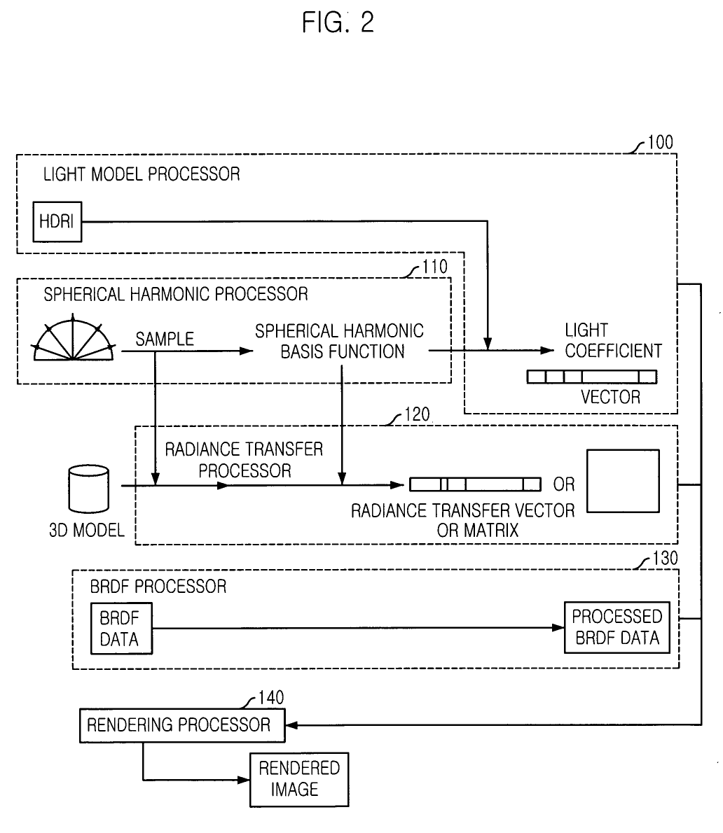

FIG. 1 is a diagram illustrating a rendering apparatus for real-time global illumination in accordance with a preferred embodiment of the present invention, and FIG. 2 is a block diagram for describing a rendering method of real-time global illumination in accordance with a preferred embodiment of the present invention.

The present invention relates to a rendering apparatus and a method thereof for real-time global illumination that enables the real-time rendering by expressing integral elements configuring a rendering equation as a dot product and previously calculating elements not varied while rendering.

The object of the rendering method according to the present invention is to render a three-dimensional (3-D) object in real-time using measured reflectance characteristics data of an object's surface and real light information obtained from an image of high dynamic range imaging (HDRI).

Since the measured reflectance characteristics of an object's surface are very diversity, rendering of the measured reflectance characteristics data is totally different from the rendering of 3-D object having glossy surface characteristics such as Lambertian, Phong or Phong-like. Therefore, the rendering apparatus according to the present invention includes modules for expressing real light information, information about how the light information is acted, and measured surface characteristics data in a frequency domain and processing the expressions in the frequency domain.

Hereinafter, the rendering apparatus for real-time global illumination according to the present invention will be described with reference to FIG. 1.

The rendering apparatus according to the present invention includes a spherical harmonic processor 100, a light model processor 110, a radiance transfer processor 120, a bidirectional reflectance distributed function (BRDF) processor 130 and a rendering processor 140.

The spherical harmonic processor 100 receives a function defined in a sphere space and transforms the received function to a spherical harmonic expression. In order to receive and transform, the spherical harmonic processor 100 includes a light sample generation module 101 for generating samples of the sphere space to use the spherical harmonic and calculating spherical harmonics basis functions for the generated samples, and a spherical harmonic module 102 for performing operations related to spherical harmonic coefficients.

The light modeling processor 110 provides modules for modeling light information. The light modeling processor 110 includes a high dynamic range imaging (HDRI) module 111 for processing HDRI as real light information, and a light modeling module 112 for modeling light information to data of frequency domain.

The radiance transfer processor 120 previously calculates how radiance information is reflected on a target object in a 3-D space. The radiance transfer processor 120 includes a radiance transfer module 121 for calculating vectors and matrixes that represents transferring of radiance.

The bidirectional reflectance distributed function (BRDF) processor 130 receives BRDF data which is measured by hardware and processes the received BRDF data to use in the rendering apparatus according to the present invention. The BRDF processor 130 includes a BRDF smoothing module 131 for transforming or smoothing the measured BRDF data to consecutive and regular data, and a BRDF search module 132 for indexing the BRDF data to search with predetermined conditions and to use the transformed and stored BRDF data while rendering.

The rendering processor 140 processes a rendering equation. The rendering processor 140 includes a rendering module 141 for calculating integral elements of the rendering equation to the dot product to be suitable to the object of the present invention.

Hereinafter, functions of each of the processors will be described in detail.

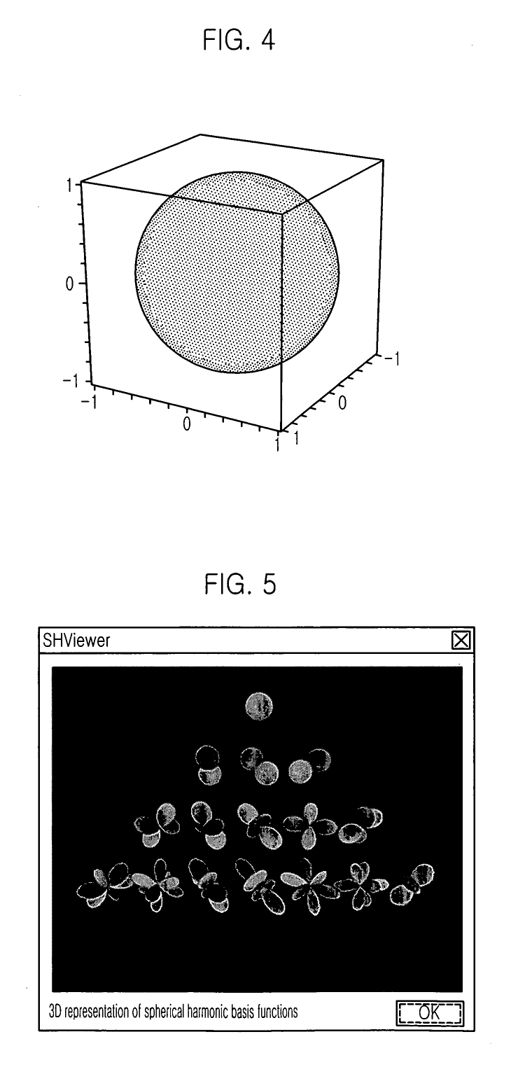

The spherical harmonic processor 100 is a set of modules performing functions related to the Spherical Harmonic theory. As shown in FIG. 1, the spherical harmonic processor 100 includes the light sample generation module 101 for generating samples shown in FIG. 4 which denotes light directions for omni-direction of 360°, and the spherical harmonic module 102 for generating spherical harmonic basis function shown in FIG. 5 for each of the light samples and providing a transform for spherical harmonic coefficient.

The light modeling processor 110 includes the HDRI processing module 111 for processing an HDRI image in order to use it as real light information and the light modeling module 112 for transforming the light information obtained from the image to spherical harmonic coefficients using the spherical harmonic basis function.

The HDRI processing module 111 loads a HDRI image and creating a database of radiance information. The light modeling module 112 calculate spherical harmonic light coefficients using radiance data from the HDRI processing module 111. If a predetermined function ƒ( ) defined in the sphere space exists, the function ƒ( ) can be expressed as the spherical harmonic coefficients.

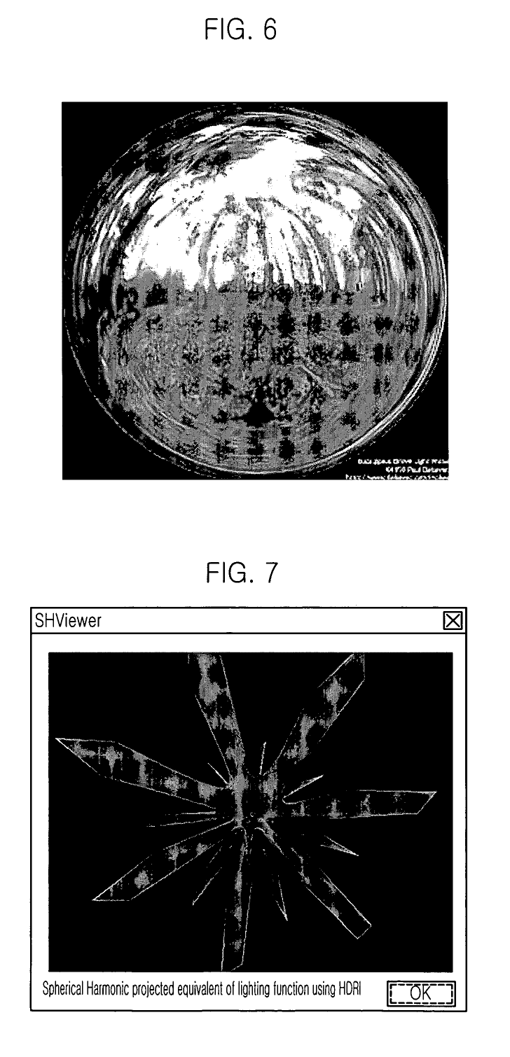

An equation transforming the function f( ) to the spherical harmonic coefficients is shown in below Eq. 1. In Eq. 1, c denotes the spherical harmonic coefficient, and y( ) denotes the spherical harmonic basis function. When the HDRI image is used as shown in FIG. 6, the spherical harmonic coefficients can be expressed as FIG. 7.
cₗ^{m}= [symbol] ₛƒ(s)yₗ^{m}ds Eq. 1

Meanwhile, the radiance transfer processor 120 includes the radiance transfer module 121 for previously calculating how each vertex of a 3-D module is reflected by the lighting samples when the 3-D object is in the sphere space having lighting samples shown in FIG. 4, and storing the calculation results.

If the surface characteristics of the 3-D object is Lambertian characteristics without reference to a viewing direction of a camera, the calculating results are expressed as vectors, and if the surface characteristics of the 3-D object is expected as an object having glossy characteristics, the calculating results are expressed as a matrix since the results of the radiance transfer are varied according to the viewing direction of the camera.

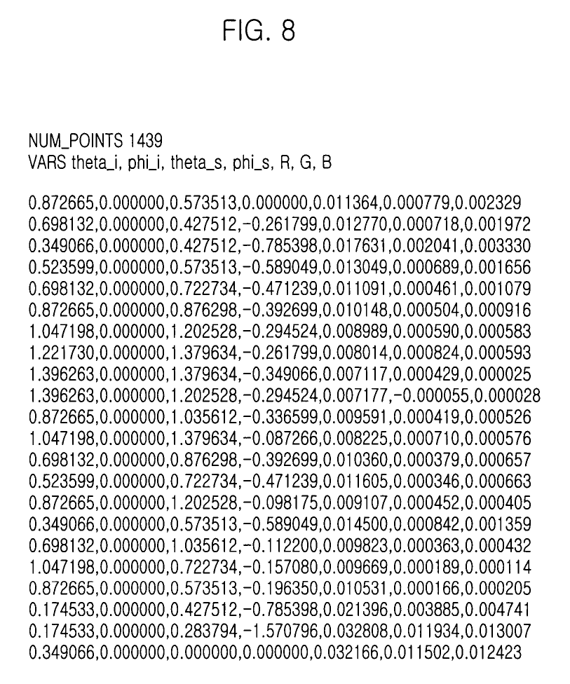

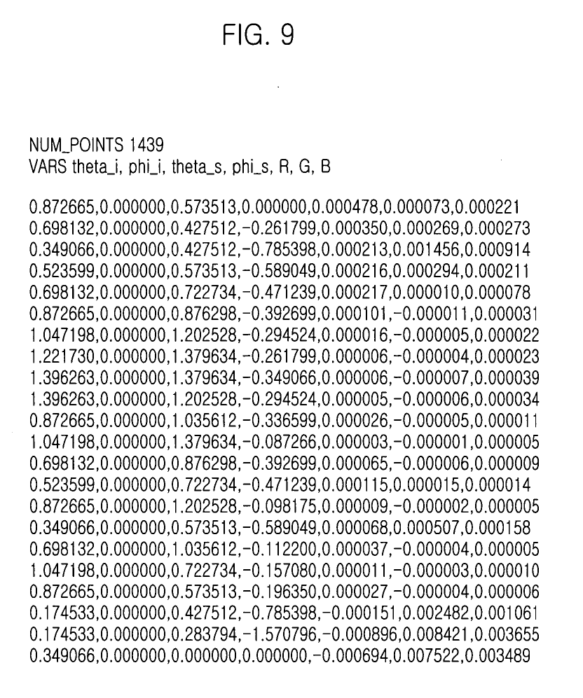

If the measured BRDF data is used directly, it determines whether the calculating results are expressed as a matrix or a vector based on glossy information in the measured BRDF data. FIG. 8 shows BRDF data having Lambertian characteristics, and FIG. 9 shows BRDF data having glossy characteristics.

The BRDF processor 130 includes the BRDF smoothing module 131 and the BRDF search module 132. The BRDF smoothing module receives the measured BRDF data and smoothes or interpolates the measured BRDF data to be suitable to the rendering apparatus according to the present invention. That is, the BRDF smoothing module creates a database of the smoothing results. The BRDF search module 132 searches BRDF data of target direction from the created database. The BRDF smoothing module 131 and the BRDF search module 132 are major functions of the present invention. That is, in the BRDF processor 130, the BRDF data of a real object, which is measured by hardware, is transformed to coefficients based on the spherical harmonic theory in order to use it for real-time rendering of a 3-D object. Usable BRDF data may be BRDF data provided by Cornel University or CURET BRDF data provided by Colombia University. However, any BRDF data measured by a typical method can be used if a loader of the data file is provided.

The BRDF data is smoothed according to the present invention as follows. The BRDF data generally includes information in a form of a file and named as theta_i, phi_i, theta_o, phi_o, and RGB data.

The file of theta_i and the file of phi_i include information about a light direction, and the files of theta_o and phi_o denote a camera direction. The file of RGB data represents RGB value. The BRDF data is arranged in ascending order based on information in the file of theta_o as a reference at first.

If the BRDF data has isotropic characteristics, information in the file of phi_i can be ignored. In this case, database of the BRDF data is created using the camera direction information which is in the files of theta_o and phi_o as a reference. A parabolic map is used to create the database of the BRDF data.

Using the parabolic map, the database of the BRDF data can be created for a hemisphere region included within 90 formed of a normal and the light direction of the 3-D object because the parabolic map can express 180° space through indexing of a target object's shape. Therefore, the parabolic map is indexed using information in the files of theta_o and phi_o.

While indexing the parabolic map, the light samples shown in FIG. 4 is used as the light direction, i.e., theta_i and phi_i. Finally, the parabolic maps are created according to each of vertexes of the target object. Values stored in the map are Spherical Harmonic BRDF coefficients and they can be calculated by Eq. 1.

Although required memory is gradually increased according to the number of vertexes of 3-D object, it does not influence to a processing speed because the Spherical Harmonic BRDF coefficients are calculated at once during pre-processing and it uses the values pre-calculated at the BRDF search module 132 during rendering.

The BRDF search module 132 uses the indexing method used in the smoothing step and it is shown in following Eq. 2. That is, the index of the parabolic map is determined using a current direction of a camera, and stored data can be obtained using the determined index. If there is no stored value, a 3×3 window is created and values around the window are obtained. The obtained values are used as a major surface region of the camera direction.

$$( u , v ) = ( \frac{{R}_{x}}{2 ( 1 + {r}_{z} )} , \frac{{r}_{y}}{2 ( 1 + {r}_{z} )} ) + \frac{1}{2} \qquad Eq . 2$$

Finally, the render processor 140 includes the rendering module 141 for solving the rendering equation using the results obtained from the above described modules. In the present invention, the rendering equation is expressed with a vector and a dot product of the vector. Accordingly, the rendering equation according to the present invention can be calculated faster than the conventional rendering equation having integral elements.

Eq. 3 shows the conventional rendering equation and Eq. 4 shows the rendering equation according to the present invention. As shown in Eq. 4, the rendering equation according to the present invention is expressed with the vector and the vector or the vector and the dot product between the vector and the matrix. Such a vector and a matrix are obtained through dividing the rendering equation into functions expressed in the sphere space, transforming the functions to coefficients and transforming the coefficients to the vector and the matrix.
Lₚ(0) [symbol] ₛL(s)ƒ(s,o)Vₚ(s)H_{N}_{ₚ}(s)ds Eq. 3

In Eq. 3, Lₚ(0) denotes a reflected light intensity, ƒ(s,o) denotes BRDF, L(s) represents an incident light intensity, Vₚ(s) is a visibility function and H_{N}_{ₚ}(s) denotes a Geometric Term.
Lₚ(0)=L·Tₚ·B Eq. 4

In Eq. 4, L is a set of coefficients for incident light information, that is, a set of Spherical Harmonic light coefficients. Tₚ is a set of coefficients for visibility and Geometric Term, and B denotes a set of BRDF data.

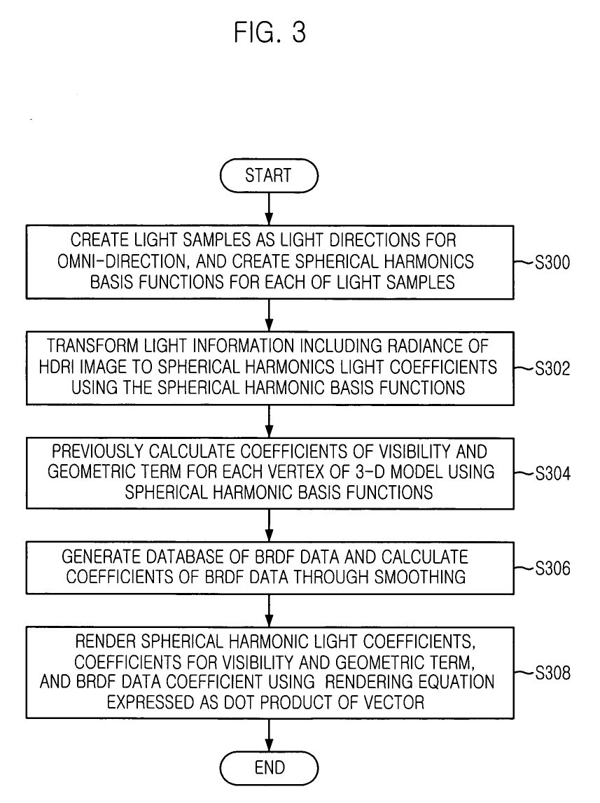

FIG. 3 is a rendering method for real-time global illumination in accordance with a preferred embodiment of the present invention.

As described above, the present invention is for expressing global illumination in real time when a 3-D object is rendered with real light information from an image. Therefore, the rendering method according to the present invention performs a function for modeling light information from the image and previously calculating how the light information of the sphere space is transferred to each vertex of the object and a function for transforming information for surface characteristics of the object to coefficients.

The present invention is for realistically rendering a virtual 3-D object in real time using real light information. Especially, the present invention creates realistic image through sufficiently reflecting the real light information to the rendering process while rendering the object in real time using a HDRI image where information of each pixel is expressed as floating point.

In order to achieve such an object of the present invention, the light information extracted from the image is transformed to expression in a frequency domain. That is, coefficients of the light information are calculated. Based on the coefficients, vector formed of N elements is obtained. Also, the present invention previously calculates how the light information is transferred to vertexes of the object in the sphere space, and the corresponding coefficients are calculated transforming the light information to the expression in the frequency domain. Herein, the coefficients can be transformed as a vector having N elements or a N×N matrix according to the surface characteristics of the 3-D object. If the surface characteristics of the object are glossy character, the coefficients are formed as the matrix.

Hereinafter, the rendering method for real-time global illumination in accordance with a preferred embodiment of the present invention will be described with reference to FIG. 3.

Referring to FIG. 3, the spherical harmonic processor 100 creates light sample representing the lighting directions for omni-direction and creates a spherical harmonics basis functions for each of the light samples at step S300.

The light modeling processor 110 transforms radiance of HDRI image to spherical harmonics light coefficients using the spherical harmonics basis function at step S302. Herein, the radiance is the light information. That is, a database of the light information is created, and the spherical harmonics light coefficients are calculated from the database of the light information using the spherical harmonics basis function.

The radiance transfer processor 120 previously calculate coefficients for the visibility and geometric term which denote the transfer characteristics of the light information, i.e., radiance, for global illumination model using the spherical harmonics basis function at step S304. That is, the radiance transfer processor 120 previously calculates coefficients of each vertex of 3-D object for the visibility and the geometric term which denote influence of lighting to the 3-D object when the 3-D object is presenting in a sphere space with the light samples, and stores the calculated coefficients.

The BRDF processor 130 creates a database for BRDF data of the object's surface and calculates the coefficients of the BRDF data through smoothing at step S306. That is, the BRDF processor 130 arranges the BRDF data measured by external hardware based on the camera direction and the light direction, and indexes the arranged BRDF data as a form of the parabolic map. Herein, the measured BRDF data is arranged based on the camera direction at first. Then, the arranged BRDF data is arranged based on the lighting direction again. When the measured BRDF data is used without arrangement, the BRDF processor 130 determines whether the glossy information is in the measured BRDF data or not. If the glossy information is in the measured BRDF data, the measured BRDF data is expressed as the matrix, and if not, the measured BRDF data is expressed as the vector.

The rendering processor 140 performs the rendering on the spherical harmonic light coefficient, the coefficient for the visibility and the geometric term and the BRDF data coefficient using the rendering equation expressed with the product of vector at step S308. Herein, the rendering processor 140 determines the index of the parabolic map using the current camera direction, searches a target one of the stored BRDF coefficients using the determined index and uses the searched BRDF coefficients during the rendering.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, the rendering apparatus and the rendering method according to the present invention can be used as a tool to create an image of 3-D object with the global illumination effect in real time using real light information in HDRI and BRDF data of the surface characteristics of the object which is measured by hardware.

Furthermore, since the rendering apparatus and the method thereof according to the present invention uses the HDRI which is an image expressing each pixel as floating point, the rendering apparatus and the method thereof according to present invention creates realistic images with global illumination effect in real time while fully reflecting the real light information to the rendering.

The present application contains subject matter related to Korean patent application No. 2004-0108828, filed in the Korean Intellectual Property Office on Dec. 20, 2004, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A rendering apparatus for real-time global illumination comprising:
a spherical harmonic processing means for creating light samples as light directions for omni-direction, and creating spherical harmonics basis functions for each of the light samples;
a light model processing means for transforming light information including radiance of a high dynamic range imaging (HDRI) image to spherical harmonics light coefficients using the spherical harmonic basis functions;
a radiance transfer processing means for previously calculating coefficients of a visibility and a geometric term for a global illumination model using the spherical harmonic basis function, where the coefficients of the visibility and the geometric term denote transfer-characteristics of the light information including radiance;
a bidirectional reflectance distributed function (BRDF) processing means for generating a database of BRDF data which is information about reflectance characteristics of an object's surface and calculating coefficients of the BRDF data through smoothing; and
a rendering means for rendering the spherical harmonic light coefficients, the coefficients for the visibility and the geometric term, and the BRDF data coefficient using a rendering equation expressed as a dot product of a vector.

2. The rendering apparatus as recited in claim 1, wherein the light model processing means creates a database of the light information including radiance of the HDRI image, and calculates the spherical harmonic light coefficients from the created database using the spherical harmonic basis function.

3. The rendering apparatus as recited in claim 1, wherein the radiance transfer processing means previously calculates and stores the coefficients for the visibility and the geometric term which denote influences of the light samples to each vertex of a 3-D model when the 3-D object is at a sphere space with the light samples.

4. The rendering apparatus as recited in claim 3, wherein the BRDF processing means arranges the BRDF data that is measured by an external hardware based on a camera direction and a light direction, indexes the arrange BRDF data as a form of a parabolic map, and storing the indexed BRDF data.

5. The rendering apparatus as recited in claim 4, wherein the BRDF processing means arranges the BRDF data based on the camera direction at first, and the rearranges the arranged BRDF data based on the light direction.

6. The rendering apparatus as recited in claim 4, wherein the BRDF data includes a light direction, a camera direction and RGB data.

7. The rendering apparatus as recited in claim 6, wherein the light samples are used as the light directions.

8. The rendering apparatus as recited in claim 4, wherein the BRDF processing means determines whether glossy information in the BRDF data in case of directly using the BRDF data measured by an external hardware, the BRDF processing means expresses as a form of a matrix if the BRDF data includes the glossy information, and the BRDF processing expresses as a form of a vector if not.

9. The rendering apparatus as recited in claim 4, wherein the rendering means decides an index of a parabolic map using a current camera direction, searches a target BRDF coefficient in stored BRDF coefficients using the decided index, and uses the searched BRDF coefficient during the rendering.

10. A rendering method for real-time global illumination comprising the steps of:
a) creating light samples as light directions for omni-direction, and creating spherical harmonics basis functions for each of the light samples;
b) transforming light information including radiance of a high dynamic range imaging (HDRI) image to spherical harmonics light coefficients using the spherical harmonic basis functions;
c) previously calculating coefficients of a visibility and a geometric term for each vertex of 3-D model using the spherical harmonic basis functions, where the coefficients for the visibility and the geometric term denote transfer-characteristics of the light information including radiance when a 3-D object is in a sphere space with the light samples;
d) generating a database of bidirectional reflectance distributed function (BRDF) data which is information about reflectance characteristics of an object's surface and calculating coefficients of the BRDF data through smoothing; and
e) rendering the spherical harmonic light coefficients, the coefficients for the visibility and the geometric term, and the BRDF data coefficient using a rendering equation expressed as a dot product of a vector.

11. The rendering method as recited in claim 10, wherein the step d) includes:
d-1) arranging the BRDF data measured by an external hardware based on a camera direction and a light direction; and
d-2) indexing the arranged BRDF data as a form of a parabolic map and storing the indexed BRDF data.

12. The rendering method as recited in claim 11, wherein in the step d-1), the BRDF data is arranged based on the camera direction at first, and then the BRDF data is rearranged based on the light direction.

13. The rendering method as recited in claim 12, wherein in the step e), an index of a parabolic map is decided using a current camera direction, searches the stored BRDF coefficients using the decided index and uses the searched BRDF coefficients for rendering.
